(19) United States
(12) Patent Application Publication
(10) Pub. No.: US 2011/0179692 A1
(43) Pub. Date: Jul. 28, 2011

(54) FISHING ROD TRANSPORTER

(76) Inventors: Scott McKnight, Jacksonville, FL (US); David McKnight, Jacksonville, FL (US)

(21) Appl. No.: 12/693,555

(22) Filed: Jan. 26, 2010

(51) Int. Cl. A01K 97/10; E05B 67/00; A47H 1/142; A01K 97/08

(52) U.S. Cl. 43/21.2; 211/70.8; 248/551; 70/20; 248/251; 43/26.1

(57) ABSTRACT

A fishing rod transporter includes a hollow tubular holder coupled to an adjustable length bar. The hollow holder defines a compartment for receiving a handle-end of a fishing rod. Slots formed in the peripheral wall of the top end of the hollow holder define a limited space for receiving a neck of a fishing reel, and the adjustable length bar is extendible to securely fit between sidewalls of a bed of a pickup truck. The adjustable length bar is extendible (by threaded engagement or ratcheting action) to securely fit between sidewalls of a bed of a pickup truck. An adjustable clamp is attached to the hollow holder and configured to secure the holder to the adjustable length bar. Optionally, a lock assembly engages the top of the hollow holder and prevents removal of the rod and reel by blocking release of the reel neck from the first slot.

### FIELD OF THE INVENTION

This invention relates generally to fishing rods, and, more particularly, to transporter configured to support and secure fishing rods off of a floor, between adjacent walls of a vehicle, such as the side walls of a pickup bed, without drilling into or otherwise damaging the walls.

### BACKGROUND

Fishing rods and reels can be extremely expensive and easily damaged or stolen. When stored loosely on the floor of a moving vehicle (e.g., the bed of a truck), rods and reels can be damaged from sliding and impacting (or being impacted by) other objects including vehicular structures and other loose items. Such storage also risks tangling of lines and gear, which can be tedious or impossible to undo. When stored in the bed of a pickup truck, closing the tailgate may also damage rods and reels.

Another serious problem is risk of theft. Expensive rods and reels are very tempting to thieves. Leaving such items unattended in an accessible area, such as the bed of a pickup truck, even for a brief moment, invites loss due to theft.

Over the years, various rod and reel holders have been devised. While they generally constitute improvements over having no holder, the known prior art holders arguably have shortcomings. Many do not keep rods and reels off the floor. Instead they secure the items to the floor, where they can be damaged from other loose items. Additionally, many requiring drilling or other forms of permanent fastening. Not only are such devices inconvenient to move and install on a new vehicle, but they tend to comprise the integrity of the finish of the vehicle, which may lead to corrosion. Furthermore, many such devices can accommodate only limited length rods, because of limitations of the holder or the manner in which it holds the rods. Moreover, many prior art holders offer little or nothing in the way of optional security accessories to guard against theft.

The invention is directed to overcoming one or more of the problems and solving one or more of the needs as set forth above.

### SUMMARY OF THE INVENTION

To solve one or more of the problems set forth above, in an exemplary implementation of the invention, a fishing rod transporter includes a hollow holder coupled to an adjustable length bar, the hollow holder defining a compartment for receiving a handle-end of a fishing rod, the hollow holder having a top end, a bottom end and a peripheral wall, a first slot formed in the peripheral wall of the top end of the hollow holder, the slot defining a limited space for receiving a neck of a fishing reel, and the adjustable length bar is extendible to securely fit between sidewalls of a bed of a pickup truck. The first slot concealing attachment elements for coupling the fishing reel to the fishing rod. The hollow holder is a tubular body. The hollow holder further includes a second slot formed in the peripheral wall of the top end of the hollow holder opposite the first slot, the second slot defining a limited space for receiving a neck of a fishing reel, and the adjustable length bar is extendible to securely fit between sidewalls of a bed of a pickup truck.

A clamp is attached to the hollow holder the clamp is configured to secure the holder to the adjustable length bar. The clamp may be removable and adjustable. The clamp may be attached to a collar that is movable along the hollow holder and locked into place using a set screw.

Optionally, a lock assembly may engage the top of the hollow holder. The lock assembly engages the top of the hollow holder, and secures a rod and reel in the hollow holder. The lock assembly includes a cap with a top opening configured to allow a rod to extend therethrough. The cap also includes a lock opening. The hollow holder includes a locking device extending from the top end. The locking device is configured to extend through the lock opening and is engageable by a lock or a cable and lock assembly. When locked, the cap prevents removal of the rod and reel by blocking release of the reel neck from the first slot.

The adjustable length bar includes a plurality of telescopically adjustable sections and a ratcheting mechanism with an actuator configured to controllably drive one section outwardly from another section. A release is provided to release the ratchet and allow retraction of the driven section. Optionally, a lock disables the actuator and/or release, thereby preventing or resisting removal of the bar assembly unless it is unlocked. A pair of gripping pads attached at opposite ends of the adjustable length bar.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side view of an exemplary tubular holder of a fishing rod transporter according to principles of the invention; and

FIG. 2 is a perspective view of an exemplary tubular holder of a fishing rod transporter according to principles of the invention; and

FIG. 3 is an exploded perspective view of an exemplary tubular holder of a fishing rod transporter according to principles of the invention; and

FIG. 4 is a perspective view of an exemplary tubular holder of a fishing rod transporter holding a rod according to principles of the invention; and

FIG. 5 is a side view of an exemplary adjustable length bar for a fishing rod transporter according to principles of the invention; and

FIG. 6 is a perspective view of an exemplary fishing rod transporter assembly comprising the adjustable length bar and a plurality of tubular holders coupled to the bar according to principles of the invention; and

FIG. 7 is a first perspective view of an exemplary truck with the exemplary fishing rod transporter assembly according to principles of the invention; and

FIG. 8 is a first perspective view of an exemplary truck with the exemplary fishing rod transporter assembly according to principles of the invention.

Those skilled in the art will appreciate that the figures are non-limiting and not intended to be drawn to any particular scale; nor are the figures intended to illustrate every embodiment of the invention. The invention is not limited to the exemplary embodiments depicted in the figures or the types of clamps, locks, adjustment mechanisms, handle configurations, fishing equipment, vehicles, shapes, relative sizes, ornamental aspects or proportions shown in the figures.

### DETAILED DESCRIPTION

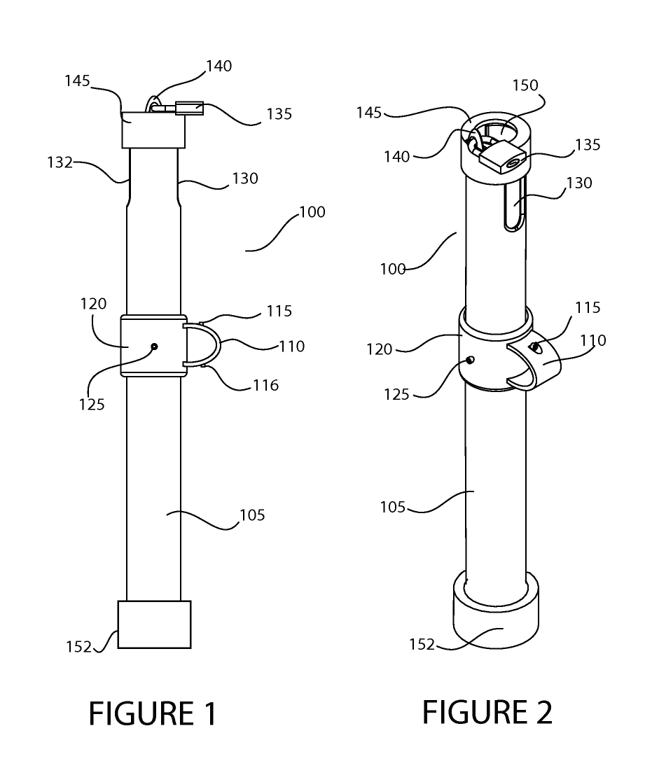

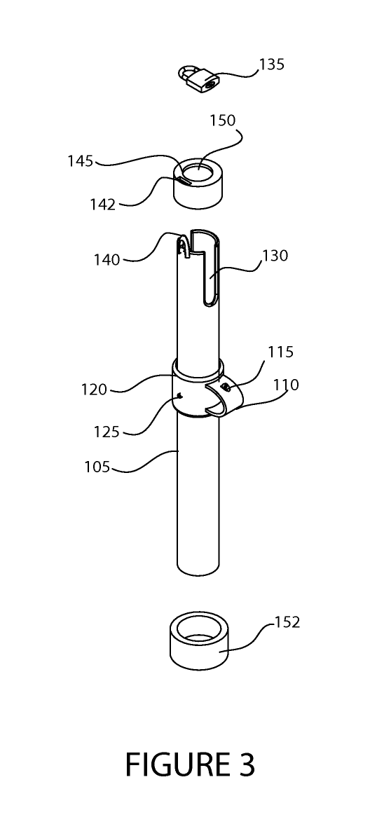

As shown in FIGS. 1 through 3, an exemplary tubular (i.e., hollow) holder 100 of a fishing rod transporter according to principles of the invention includes a tubular body 105. While the term tubular is used herein, the cross section is not limited to any particular shape, circular or otherwise. The tubular body 105 provides a compartment for receiving the handle-end of a fishing rod. One or more slots 130, 132 at the top end of the tubular body 105 are provided to receive the neck of a reel assembly. The slots may be sized to receive the neck but conceal elements attaching the reel to the rod, such that the reel cannot be removed from the rod while contained in the holder 100.

In one embodiment, a clamp 110 is attached to the tubular body 105. The clamp 110 is configured to secure the holder 100 to an adjustable length bar. The clamp 100 may be adjustable or fixed, removable or permanently attached. In a preferred embodiment, the clamp 100 is removable and adjustable to facilitate coupling to the bar. Thus, for example, the clamp 100 may be removably attached using fasteners such as screws 115, 166. The clamp 100 may also be attached to a collar 120, that may be moved (i.e., slid) along the length of the tubular body 105 and locked into place using a locking means such as a set screw 125. In another embodiment, another type of mechanism for clamping the bar may be used. Such mechanisms include, without limitation, a band clamp or web clamp; bar clamp, F-clamp or sliding clamp; Cardellini clamp; C-clamp (or G-clamp); a Kant-Twist clamp; pipe clamp; hose clamp or Marman clamp. In yet another embodiment, the tubular body 105 is permanently secured to the bra by welding or bonding. In still another embodiment the tubular body may be secured to the bar using screws or nuts and bolts.

Optionally, a lock assembly is provided for engaging the top of the tubular body. The lock assembly secures a rod and reel in the tubular body 105. An exemplary lock assembly comprises a cap 145 with a top opening 150 configured to allow a rod to extend therethrough. The cap 145 also includes a lock opening 142 through which a locking device, such as an eyelet or C-shaped member 140 extends. A padlock or similar lock 135 may then be secured to the exposed locking member 140 extending through the corresponding opening 142 in the cap 145. When locked in place, the cap 145 prevents removal of the rod and reel by blocking release of the reel neck from the slot 130, 132.

Alternatively, a cable with loops at its ends, may run through the locking member 140 of each adjacent tubular holder. Then the loops may be joined with a padlock, or be independently locked with a padlock. Such an embodiment allows unlocking of one lock to remove any and all secured rods and reels.

An optional cushion 152 is provided to protect the bottom end of the tubular body 105. The cushion 152 comprises a rubber, silicone, another durable elastomer or a foam polymer (e.g., Neoprene®) sleeve that fits over the bottom end of the tubular body 105. The bottom end of the tubular body 105 and the cushion are perforated to allow drainage of water caught in the tubular body 105. The cushion 152 helps protect the floor and wall of the truck bed from damage and dampens any noise generated by contact between the bottom end of the tubular body 105 and truck bed.

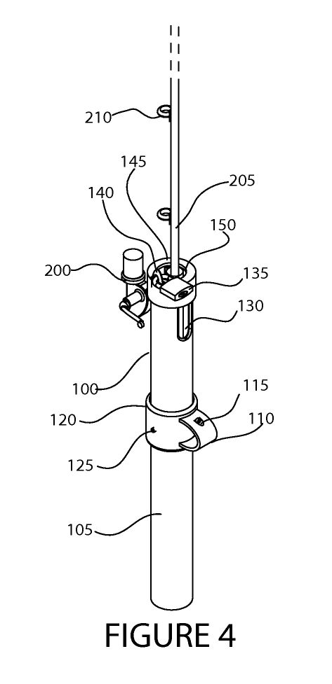

Referring now to FIG. 4, a perspective view of an exemplary tubular holder of a fishing rod transporter holding a rod according to principles of the invention is provided. The reel assembly 200 extends through the slot 132, via the neck of the reel. The rod 205 and eyelets 210 with any line and terminal tackle, extend through the top opening 150 in the locking cap 145. The lock member 140 engaged by the padlock 135, prevents removal of the cap 145, which prevents release of the neck of the reel 200 extending through the slot 132.

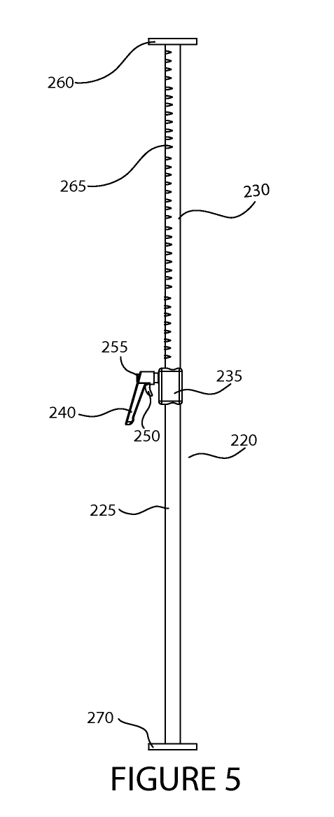

Referring now to FIG. 5, a side view of an exemplary adjustable length bar assembly 220 or a fishing rod transporter according to principles of the invention is shown. The bar includes a plurality of adjustable sections 225, 230. By way of example and not limitation, section 225 may be tubular and section 230 may have a slightly smaller outer diameter than the inner diameter of the first section 225. Thus, section 230 may extend telescopically from section 225.

Extension may be effectuated mechanically, hydraulically or pneumatically. Illustratively, a ratcheting mechanism 235 with a handle actuator 240 may drive the second section 235 by engaging notches 265 in the second section and urging the second section outwardly from the first section 225. A release 250 may be provided to release the ratchet and allow retraction of the second section 230. A lock 255 may also be provided to disable the actuator and/or release, thereby preventing or resisting removal of the bar assembly unless it is unlocked. Alternatively, the second section 230 may include a threaded portion, threadedly engaged by a corresponding portion of the first section 225. In such case, turning the second section 230 relative to the first causes extension or retraction, depending upon the direction. As another alternative, telescopic tubes with locking pins and a padlock may be used to secure the bar in any one of a number of positions. A ratcheting or threaded assembly that provides infinite (i.e., continuous) or near-infinite (small increment) adjustment is preferred for convenience, reliability and cost effectiveness.

A pair of gripping pads 260, 270 are provided at opposite ends of the bar assembly 220. The pads 260, 270 engage walls, between which the bar assembly is frictionally secured. The pads may be articulating, pivoting, adjustable and removable or permanently fixed. As the bar assembly 220 is lengthened, the pads exert pressure against the walls. Frictional engagement prevents the bar assembly from moving. The pads may be comprised of a rigid body coated or covered with a rubber, plastic or other material that is relatively soft but features a relatively high coefficient of friction. The softness prevents damage to the vehicle finish. The friction helps secure the bar assembly 220 in place. In a pivoting or swiveling embodiment, a pivot or ball joint connects the pad to the bar. This allows adjustment to accommodate irregular wall surfaces and misalignment.

Advantageously, the adjustable length bar assembly is extendible to securely fit between sidewalls of a bed of a pickup truck and secure the adjustable length bar to the bed of the pickup truck by applying pressure between the sidewalls of the bed of the pickup truck without any means for penetrating the sidewalls of the pickup truck. Thus, no screws are needed to secure the bar to the bed. No drilling or penetration is necessary to secure the bar to the bed. This avoids damage to the truck bed.

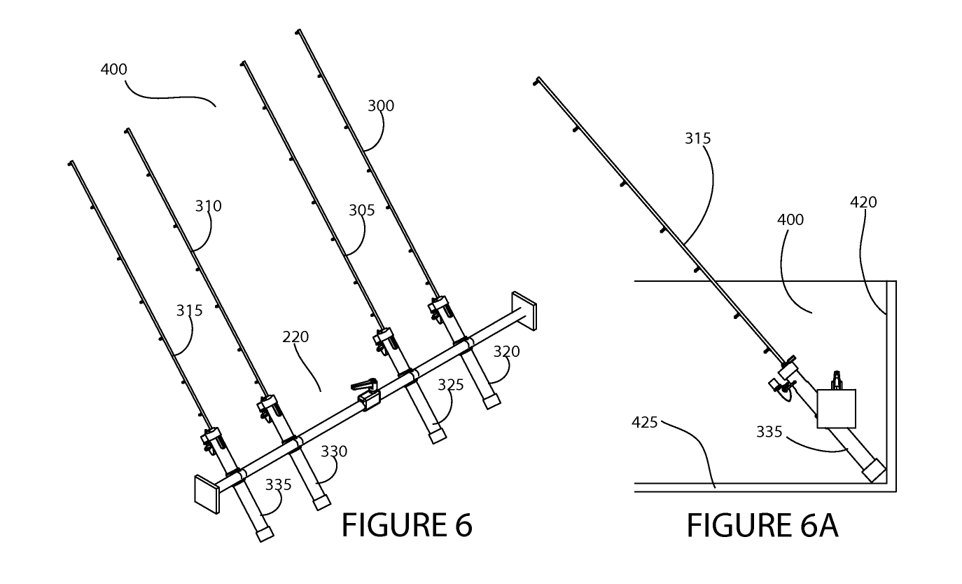

Referring now to FIG. 6, a perspective view of an exemplary fishing rod transporter assembly comprising the adjustable length bar assembly 220 and a plurality of tubular holders 320-335 coupled to the bar assembly 220 using corresponding clamps, according to principles of the invention is shown. A real and rod 300-315 is secured in each holder 320-335 for safe and secure transport. The bar assembly 220 is extendable to securely fit between parallel walls, such as the side walls of a truck bed.

FIG. 6A provides a side view of the system installed in a cutaway view of a truck bed. The pads 260, 270 of the bar are pressed firmly against sidewalls 400, 415 of the truck bed. The tubular holders 320-335 are angled and positioned such that the bottom ends of the tubular holders 320-335 are wedged between the front wall 420 of the truck bed and the floor 425 of the truck bed. This is the preferred configuration for transporting rods and reels in a truck bed in accordance with the invention.

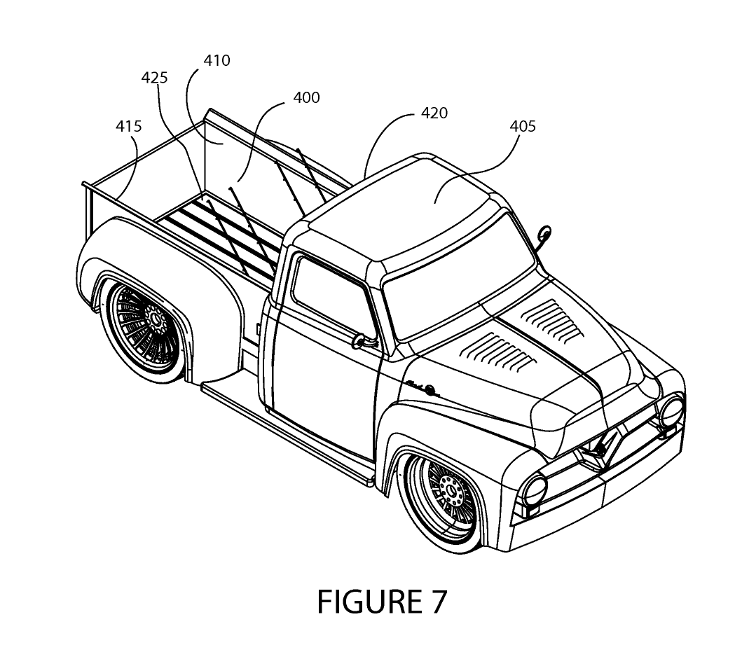

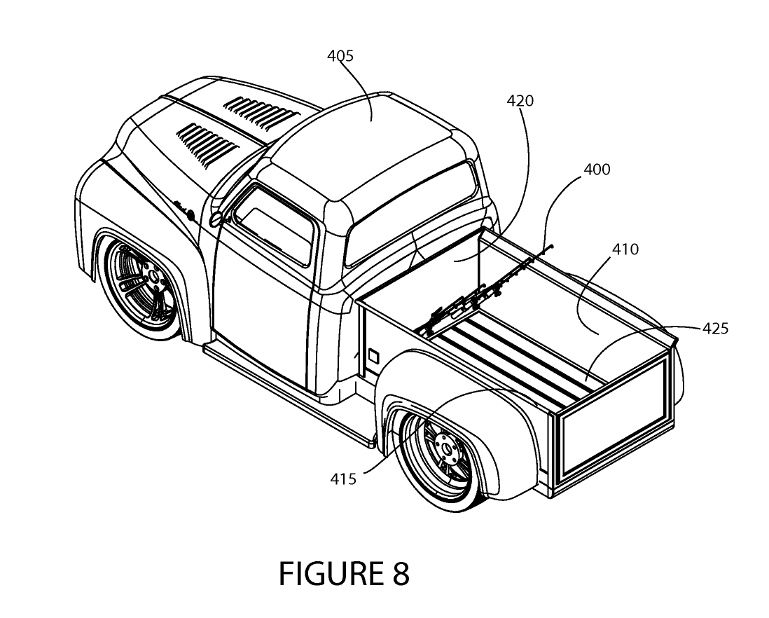

FIGS. 7 and 8 provide perspective views of an exemplary truck 405 with an exemplary fishing rod transporter assembly 400 according to principles of the invention. The holders and rods with reels 300-315 are angled from the lower portion of the front wall 420 of the bed and the bar assembly 220. Preferably, the bar assembly 220 is positioned to secure the holders in the corner defined by the floor and front wall of the bed. The bar assembly 220 is held in place between the side walls 410, 415 of the bed.

The tubular holder 100 may be comprised of any material that exhibits sufficient rigidity and strength to support fishing equipment during transport. By way of example and not limitation, the tubular holder 100 may be comprised of wood or metal such as steel, stainless steel, aluminum, an alloy or some other metal, which may be coated (e.g., anodized and/or painted or powder coated or resin coated) to resist corrosion, to prevent damage to the rod and reel, and to maintain good aesthetics.

Alternatively, the tubular holder 100 may be fabricated using plastic by any suitable plastic forming technique. For example, the tubular holder 100 may be comprised of a plastic or polymeric material, such as polyvinyl chloride (PVC), nylon, polysulfone, polyethylene, polypropylene, polystyrene, acrylics, cellulosics, acrylonitrile-butadiene-styrene (ABS) terpolymers, urethanes, thermo-plastic resins, thermo-plastic elastomers (TPE), acetal resins, polyamides, polycarbonates and/or polyesters. Other suitable polymeric compositions are known to those familiar with the art and may also be used in accordance with the present invention. Preferably the chosen material is relatively inexpensive, produces a rigid, durable and strong product, is easy to use in manufacturing operations and results in an aesthetically acceptable product.

The material may further include additives to provide desired properties such as desired colors, structural characteristics, glow-in-the dark properties and thermal reactivity (e.g., color changes according to heat). Illustratively, phosphorescent polymer additives, such as aluminate based phosphors, may be added to adsorb light energy and continue to release that energy as visible light, after the energy source is removed. Advantageously, such an embodiment provides a glow-in-the-dark holder that is easy to locate at night.

The tubular holder 100 may be produced using any suitable manufacturing techniques known in the art for the chosen material, such as (for example) injection, compression, structural foam, blow, or transfer molding; polyurethane foam processing techniques; vacuum forming; casting; milling; and extrusion. Preferably the manufacturing technique is suitable for mass production at relatively low cost per unit, and results in an aesthetically acceptable product with a consistent acceptable quality and structural characteristics.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A fishing rod transporter comprising a hollow holder coupled to an adjustable length bar, said hollow holder defining a compartment for receiving a handle-end of a fishing rod, said hollow holder having a top end, a bottom end and a peripheral wall, a first slot formed in the peripheral wall of the top end of the hollow holder, said slot defining a limited space for receiving a neck of a fishing reel, and said adjustable length bar being extendible to securely fit between sidewalls of a bed of a pickup truck and secure the adjustable length bar to the bed of the pickup truck by applying pressure between the sidewalls of the bed of the pickup truck without any means for penetrating the sidewalls of the pickup truck.

2. A fishing rod transporter according to claim 1, said first slot concealing attachment elements for coupling the fishing reel to the fishing rod.

3. A fishing rod transporter according to claim 1, said hollow holder being a tubular body.

4. A fishing rod transporter according to claim 1, said hollow holder further comprising a second slot formed in the peripheral wall of the top end of the hollow holder opposite the first slot, said second slot defining a limited space for receiving a neck of a fishing reel, and said adjustable length bar being extendible to securely fit between sidewalls of a bed of a pickup truck and secure the adjustable length bar to the bed of the pickup truck by applying pressure between the sidewalls of the bed of the pickup truck without any means for penetrating the sidewalls of the pickup truck.

5. A fishing rod transporter according to claim 1, further comprising a clamp attached to the hollow holder said clamp being configured to secure the holder to the adjustable length bar.

6. A fishing rod transporter according to claim 5, said clamp being removable and adjustable in position.

7. A fishing rod transporter according to claim 5, said clamp being attached to a collar that is movable along the hollow holder.

8. A fishing rod transporter according to claim 5, said clamp being attached to a collar that is movable along the hollow holder and locked into place using a set screw.

9. A fishing rod transporter according to claim 1 further comprising a lock assembly engaging the top of the hollow holder.

10. A fishing rod transporter according to claim 1 further comprising a lock assembly engaging the top of the hollow holder, said lock assembly securing a rod and reel in the hollow holder.

11. A fishing rod transporter according to claim 1 further comprising a lock assembly engaging the top of the hollow holder, said lock assembly securing a rod and reel in the hollow holder, said lock assembly comprising a cap with a top opening configured to allow a rod to extend therethrough.

12. A fishing rod transporter according to claim 1 further comprising a lock assembly engaging the top of the hollow holder, said lock assembly securing a rod and reel in the hollow holder, said lock assembly comprising a cap with a top opening configured to allow a rod to extend therethrough, said cap including a lock opening, and said hollow holder including a locking device extending from the top end, and said locking device extending through the lock opening and being engageable by a lock.

13. A fishing rod transporter according to claim 1 further comprising a lock assembly engaging the top of the hollow holder, said lock assembly securing a rod and reel in the hollow holder, said lock assembly comprising a cap with a top opening configured to allow a rod to extend therethrough, said cap including a lock opening, and said hollow holder including a locking device extending from the top end, and said locking device extending through the lock opening and being engaged by a padlock.

14. A fishing rod transporter according to claim 1 further comprising a lock assembly engaging the top of the hollow holder, said lock assembly securing a rod and reel in the hollow holder, said lock assembly comprising a cap with a top opening configured to allow a rod to extend therethrough, said cap including a lock opening, and said hollow holder including a locking device extending from the top end, and said locking device extending through the lock opening and being engaged by a padlock, said cap preventing removal of the rod and reel by blocking release of the reel neck from the first slot.

15. A fishing rod transporter according to claim 1 further comprising a lock assembly engaging the top of the hollow holder, said lock assembly securing a rod and reel in the hollow holder, said lock assembly comprising a cap with a top opening configured to allow a rod to extend therethrough, said cap including a lock opening, and said hollow holder including a locking device extending from the top end, and said locking device extending through the lock opening and being engaged by a cable and lock assembly, said cap preventing removal of the rod and reel by blocking release of the reel neck from the first slot.

16. A fishing rod transporter according to claim 1, the bar including a plurality of telescopically adjustable sections.

17. A fishing rod transporter according to claim 1, the bar including a plurality of telescopically adjustable sections and a ratcheting mechanism with an actuator configured to controllably drive one section outwardly from another section.

18. A fishing rod transporter according to claim 17, further comprising a release to release the ratchet and allow retraction of the driven section.

19. A fishing rod transporter according to claim 18, further comprising a lock configured to disable the actuator and release, thereby preventing or resisting removal of the bar assembly unless it is unlocked.

20. A fishing rod transporter according to claim 18, further comprising a pair of gripping pads attached at opposite ends of the adjustable length bar.
